(19) United States
(12) Patent Application Publication
(10) Pub. No.: US 2026/0298436 A1
(43) Pub. Date: Oct. 1, 2026

(54) LIGHTING DEVICE FOR VEHICLES

(71) Applicant: HELLA GMBH & CO. KGAA, Lippstadt (DE)

(72) Inventors: Carsten Hohmann, Warstein (DE); Martin Mügge, Geseke (DE)

(21) Appl. No.: 19/577,781

(22) Filed: Mar. 25, 2026

(30) Foreign Application Priority Data
Mar. 26, 2025 (DE) 102025111709.8

(51) Int. Cl. F21S 43/20; F21S 43/14; F21S 43/239; F21S 43/245; F21S 43/27; F21S 43/37; F21W 103/15; F21W 103/20; F21W 103/35; F21W 103/55

(52) U.S. Cl. CPC F21S 43/26271; F21S 43/14; F21S 43/239; F21S 43/245; F21S 43/26241; F21S 43/265; F21S 43/27; F21S 43/37; F21W 2103/15; F21W 2103/20; F21W 2103/35; F21W 2103/55

(57) ABSTRACT

The invention relates to a lighting device for vehicles. The lighting device includes a flat light guide unit for generating a predetermined light function. The flat light guide unit includes opposite flat sides at which coupled-in light can be totally internally reflected in a light guiding direction within a flat light guide, and a narrow side connecting the flat sides at which light generated by a light source can be coupled into the flat light guide. The lighting device further includes a retroreflector unit for generating a retroreflecting function, the retroreflector unit including a plurality of retroreflecting elements arranged in a surface The retroreflector unit is arranged offset in a main radiation direction relative to the flat light guide of the flat light guide unit, and wherein the flat light guide of the flat light guide unit is arranged behind the retroreflector unit in the main radiation direction.

### CROSS-REFERENCE TO RELATED APPLICATIONS

This application claims the benefit of German Patent Application 10-2025-111-709.8, filed Mar. 26, 2025, the disclosure of which is incorporated by reference in its entirety.

### FIELD OF THE INVENTION

The invention relates to a lighting device for vehicles having a flat light guide unit for generating a predetermined light function containing opposite flat sides, at which coupled-in light can be totally reflected in a light guiding direction within a flat light guide, a narrow side connecting the flat sides, at which a light generated by a light source can be coupled into the flat light guide, and having a retroreflector unit for generating a retroreflecting function containing a plurality of retroreflecting elements arranged in a surface, at which a light generated by a light source can be coupled into the flat light guide, wherein the retroreflector unit is arranged offset in a main radiation direction relative to the flat light guide of the flat light guide unit.

### BACKGROUND OF THE INVENTION

A lighting device for vehicles is known from DE 100-47-209 A1, which has a light source and an optical unit for generating a signal light function. A retroreflector unit is integrated in a cover glass of the lighting device, wherein retroreflecting elements of the retroreflector unit are arranged on a rear side of the cover glass arranged at the rear in the main radiation direction.

DE 10-2013-110-839 A1 provides a lighting device for vehicles with a flat light guide unit for generating a predetermined light function and a retroreflector unit for generating a retroreflecting function. The flat light guide unit has a flat light guide with opposing flat sides for forwarding coupled-in light in a predetermined light guiding direction. A plurality of light sources are arranged in rows on one narrow side of the flat light guide and their light is coupled into the flat light guide on the narrow side. The flat light guide has decoupling elements on a rear flat side in the main radiation direction, so that the coupled light incident on them is deflected in the direction of a front flat side in the main radiation direction and decoupled there on the front flat side. The retroreflector unit is arranged behind the flat light guide in the main radiation direction. Because the flat light guide is transparent, when the light sources are switched off, light from outside can pass through the flat light guide onto the retroreflector unit, from where it is reflected back by means of the retroreflecting elements and, after passing through the flat light guide again, is emitted into the surroundings. A disadvantage of the lighting device is that decoupling elements or scattering optics elements are arranged on a rear side of the flat light guide to ensure a sufficiently high light output for the signal light function.

### SUMMARY OF THE INVENTION

The object of the present invention is therefore to further develop a lighting device for vehicles with an integrated retroreflector unit in such a way that, on the one hand, the lighting device has a homogeneous appearance and, on the other hand, the retroreflector unit is integrated in a space-saving manner.

To achieve this object, the invention is characterized in conjunction with the disclosed embodiments, in that the flat light guide of the flat light guide unit is arranged behind the retroreflector unit in the main radiation direction.

The particular advantage of the invention is that the scattering effect of the retroreflector unit arranged in front of the flat light guide in the main radiation direction can be used to influence the light coupled out at a front flat side of the flat light guide in a scattering manner. This gives the light function of the flat light guide unit a homogeneous appearance or creates a homogeneous luminous surface without the flat light guide having to have a scattering optical structure. The flat light guide can be optics-free. This has the advantage of reducing manufacturing costs and minimizing the installation depth of the lighting device.

According to a further development of the invention, a reflective element is arranged on a rear flat side of the flat light guide arranged at the rear in the main radiation direction of the lighting device, so that light coupled out at the rear flat side can be reflected back into the flat light guide so that this light can be used for light decoupling at the front flat side of the flat light guide. This allows the light output to be optimized, as virtually all of the coupled-in light can be used for the lighting function of the flat light guide unit.

According to a further development of the invention, the reflective element is designed as a reflective foil or as a mirrored inner surface of a housing shell of the lighting device. The advantage of this is that the high light output for the lighting function of the surface light unit can be achieved in a space-saving and cost-effective manner. This means that no scattering optics elements need to be integrated in the flat light guide.

According to a further development of the invention, at least one transparent optical foil or a transparent optical plate with a micro-optical structure is provided between the retroreflector unit and the flat light guide, so that the light coupled out at the front flat side of the flat light guide can be scattered and homogenized. This has the advantage that the signal appearance of the luminous surface can be influenced or the appearance of the luminous surface determined by the shape of the retroreflecting elements can be modified. Advantageously, diffuse light emission on the front flat side of the flat light guide is only influenced to a small extent by the upstream retroreflecting elements. This provides the viewer with uniform illumination regardless of direction.

According to a further development of the invention, the retroreflector unit is arranged integrated in a cover glass, so that the number of components can be reduced.

According to a further development of the invention, the cover glass, the optical foil or the optical plate and the flat light guide are sandwiched together, wherein at least the cover glass is enclosed by a housing frame firmly connected to the housing shell. Advantageously, this creates a flat unit that can be placed as a single unit in the interior of a car body housing or as a plurality of small units staggered in the main radiation direction or arranged in any geometric arrangement relative to each other within the car body opening. Depending on the size of the unit, an individual appearance of the lighting device can thus be created, wherein the units are designed plate-shaped or preferably flat. Since the units are preferably of the same design, the appearance of the plurality of units, which are arranged in a specific geometric composition in a car body housing space, is always uniform. It is assumed here that a cover glass closing the car body housing opening is optics-free.

According to a further development of the invention, the cover glass with the retroreflecting elements arranged on the rear side thereof rests directly against a front flat side of the flat light guide or optical foil or optical plate. This ensures that the light emitted via the front flat side of the flat light guide is influenced in the same way, so that one of the flat light guides has a homogeneous, uniform appearance over the entire light outcoupling surface.

According to a further development of the invention, the retroreflecting elements are designed as triple optics, which correspond to the contour of a cube cut off at a single edge. Three faces of a cube per retroreflecting element thus rise from a base surface on the rear side of the cover glass. This elevation of the retroreflecting elements from the base surface of the rear-side cover glass can be in the millimeter range. Alternatively, the elevation or the dimension of the retroreflecting elements can also be in the micrometer range, so that as micro-retroreflecting elements they create a relatively thin cover glass.

According to a further development of the invention, the cover glass of the lighting device is crystal clear or colored depending on the desired signal light function. Advantageously, the lighting device can be used flexibly depending on different signal light functions.

### BRIEF DESCRIPTION OF THE DRAWINGS

Exemplary embodiments of the invention are explained in more detail below with reference to the drawings. In the drawings:

FIG. 1 is an exploded view of a light module of the invention viewed from a front side;

FIG. 2 is the exploded view of the light module according to FIG. 1, viewed from the rear;

FIG. 3 is a rear side depiction of a cover glass of the light module;

FIG. 4 is a vertical section through a light module according to an alternative embodiment of the invention; and

FIG. 5 is a top view of a lighting device with a plurality of light modules arranged in a stepped and offset manner in relation to each other.

### DETAILED DESCRIPTION

A lighting device can have one or more light modules, which are described below. The lighting device can be used as a combination rear light to generate a predefined signal light function, for example tail light, brake light, reversing light or direction indicator light. Additionally or alternatively, the lighting device can be used to generate a side marker light function.

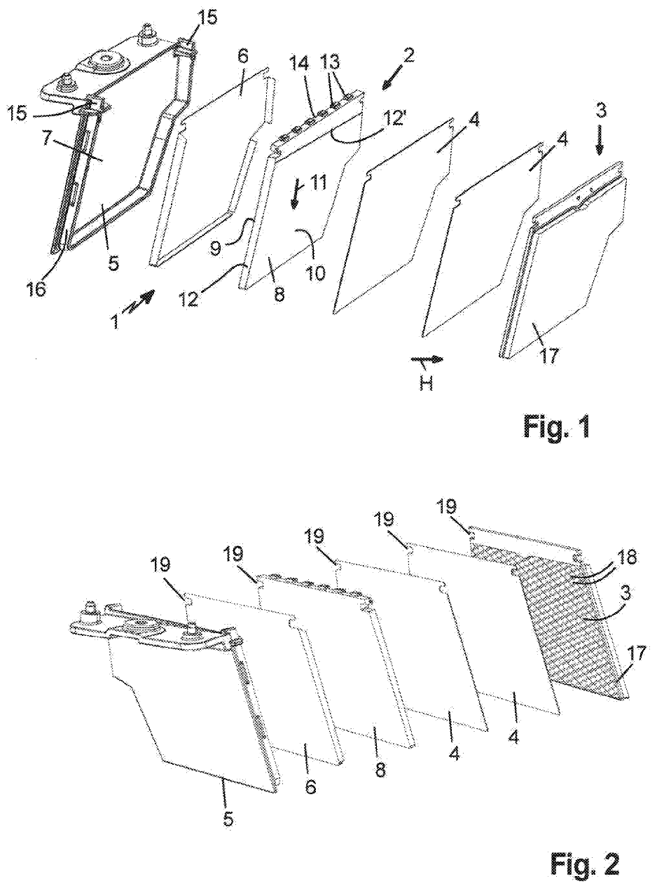

According to a first embodiment as shown in FIGS. 1 to 3, a light module 1 is provided which has a flat light guide unit 2 for generating a predetermined signal light function and a retroreflector unit 3 for generating a retroreflecting light function. In addition, the light module 1 has at least one transparent optical foil 4 or a transparent optical plate, wherein the transparent optical foil 4 or the transparent optical plate are arranged between the flat light guide unit 2 and the retroreflector unit 3. In addition, the light module 1 has a housing shell 5 in which the components of the light module 1, namely the flat light guide unit 2, the at least one optical foil 4 and the retroreflector unit 3, are mounted. Preferably, a reflective foil 6 is provided between the housing shell 5 and the flat light guide unit 2, which has a reflective surface at least on a front side facing the flat light guide unit 2, so that light coupled out from the back of the flat light guide unit 2 against a main radiation direction H is reflected back into the flat light guide unit 2 by the reflective foil 6.

The housing shell 5 has a base 7 which, according to an alternative embodiment of the invention not shown, can be mirrored so that the reflective foil 6 can be dispensed with. The mirrored base 7 of the housing shell 5 thus forms a mirrored inner surface of the housing shell 5.

The flat light guide unit 2 has a flat light guide 8, which has opposite flat sides 9, 10, at which coupled-in light is transmitted in the light guiding direction 11 by total reflection. The flat sides 9, 10 are connected to each other via narrow sides 12. In the present exemplary embodiment, a narrow side 12′ and a row of light sources 13, which are preferably designed as LED light sources, are arranged, the emitted light of which is coupled into the flat light guide 8 at the narrow side 12′ and is transferred in the light guiding direction 11 at a rear flat side 9 and a front flat side 10 of the flat light guide 8.

The light sources 13 are arranged on a common elongated printed circuit board 14, which is placed or plugged onto the narrow side 12′ of the flat light guide 8. An unambiguous geometric relative position between the light sources 13 on the one hand and the flat light guide 8 is achieved in that the printed circuit board 14 is positively and non-positively connected to fastening webs 15 of the housing shell 5.

The housing shell 5 has a raised frame 16 projecting from the base 7, which is dimensioned in such a way that the reflective foil 6, the flat light guide 8, the at least one transparent optical foil 4 and a transparent cover glass 17, in which the retroreflector unit 3 is integrated, are inserted with clearance and preferably arranged by latching in the recess of the housing shell 5 bounded by the frame 16. The flat light guide 8 and the cover glass 17 are designed to be plate-shaped and flat.

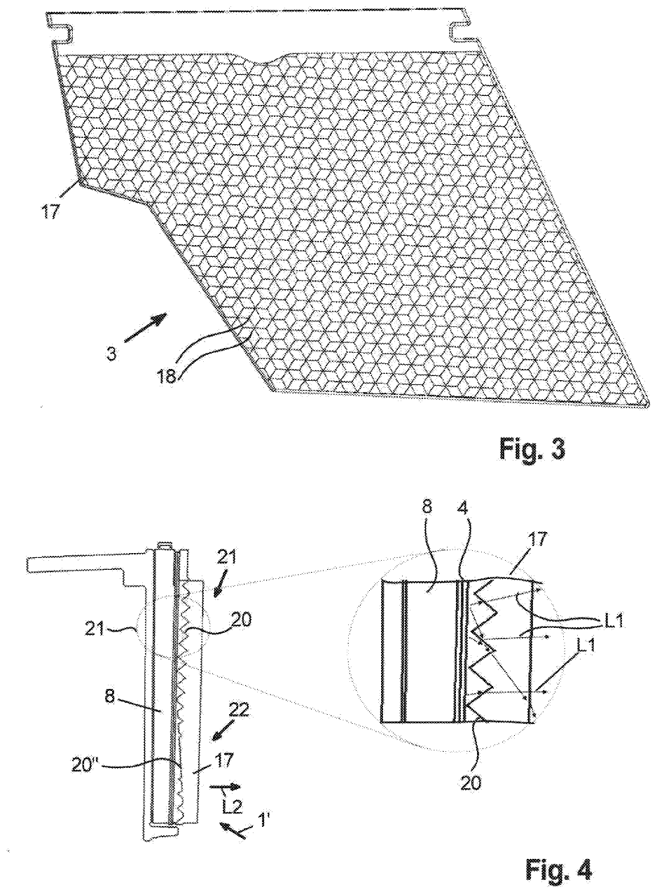

As can be seen in particular from FIG. 3, the retroreflector unit 3 is arranged on a rear side of the cover glass 17 facing the flat light guide 8. The retroreflector unit 3 has a plurality of retroreflecting elements 18, which are arranged adjacent to one another. The retroreflecting elements 18 are each designed as triple optics, which correspond to the contour of a cube cut off at a single edge. Three faces of a cube thus form the respective triple optic. The triple optical elements have the same dimensions and extend over the entire optically effective rear side of the cover glass 17.

According to a first variant, the retroreflecting elements 18 can rise from the rear side of the cover glass 17 in a millimeter range. The retroreflecting elements 18 each rise from a base surface thereof on the rear side of the cover glass 17, wherein the base surface has a size of 1 mm to 4 mm, in particular 1.8 mm to 2.5 mm.

According to an alternative embodiment of the invention, the retroreflecting elements 18 can rise from the rear side of the cover glass 17 as micro retroreflecting elements in a micrometer range.

The micro-retroreflecting elements each rise from a base surface thereof on the rear side of the cover glass 17, wherein the base surface has a size of 0.3 mm to 0.9 mm, in particular 0.7 mm.

A reflective surface formed by the retroreflecting elements 18 essentially corresponds to an optically effective surface of the flat light guide 8. To form the light module 1, the cover glass 17, the at least one optical foil 4, the flat light guide 8 and, if applicable, the reflective foil 6 lie flat and sandwiched together in the housing shell 5. They are enclosed by the frame 16 of the housing shell 5. The components inserted into the housing shell 5, namely the reflective foil 6, the optical foil 5, the flat light guide 8 and the cover glass 17, have hook-shaped recesses 19 on a common edge, by means of which they can be placed and fastened to the housing shell 5 in a form-fitting manner.

The retroreflector unit 3 is thus offset parallel to the flat light guide unit 2 and arranged in the main radiation direction H, namely in front of the flat light guide unit 2 in the main radiation direction H. The at least one optical foil 4 can preferably have micro-optical elements on a front side facing the cover glass 17 for scattering the light L1 coupled out from the front flat side 10, so that the light is scattered.

The flat light guide 8 is designed to be optics-free. The rear flat side 9 and the front flat side 10 are formed to be flat or smooth. A first part of the light coupled into the flat light guide 8 by the light sources 13 at the narrow side 12′ on the light coupling side is totally reflected at the rear flat side 9 and at the front flat side 10 of the flat light guide 8 until it strikes the rear flat side and/or the front flat side at such a steep angle that it emerges at the front flat side of the flat light guide in the main radiation direction. A second part of the coupled-in light is coupled out at the rear flat side 9 of the flat light guide 8. This second part of the coupled-in light is reflected back in the direction of the rear flat side 9 by the reflective foil 6, so that it re-enters the flat light guide at the rear flat side and then emerges directly and/or after further total reflection at the rear flat side 9 or at the front flat side 10 in the main radiation direction H at the front flat side 10 of the flat light guide 8. The reflective foil 6 thus serves as a supporting means of light outcoupling. The main means of light outcoupling is formed by the preferably parallel rear flat side 9 and the front flat side 10 of the flat light guide 8.

The cover glass 17 provided with the retroreflecting elements 18 can be crystal clear or colored depending on the desired signal light function. If the cover glass is designed to be crystal clear, the light source 13 must emit light of a signal color corresponding to the signal light function. If the signal light function is a tail light, for example, the light source 13 should emit light of a red color. If the signal light function is a direction indicator light function, the light source 13 should emit light of a yellow light color. The cover glass 17 can be colored red, for example, if the signal light function is to be a tail light and/or brake light function. In this case, the light source 13 can emit light of white light color.

As can be seen from FIGS. 1 and 2, the light sources 13 follow the contour of the light in-coupling narrow side 12′. The light sources 13 can emit light of the same color or different colors.

The retroreflecting elements 18 are formed on the rear of the cover glass 17. Preferably, the surface of the retroreflector unit 3 corresponds to the surface of the flat light guide unit 2.

According to an alternative embodiment of the invention not shown, the retroreflector unit 3 can cover only a partial region of the flat light guide unit 2. The advantage of this is that a plurality of signal light functions can be generated simultaneously, for example side marker light, tail light and brake light functions.

According to a further embodiment of the invention as shown in FIG. 4, a light module 1′ is provided which differs from the light module 1 described above in that the cover glass 17 does not have the same retroreflecting elements on the rear side, but different retroreflecting elements 20, 20′. The cover glass 17 thus has a first partial region 21 in which the retroreflecting elements 20 have a relatively large elevation. This results in a relatively wide scattering of the light L1 emitted by the flat light guide 8. A second partial region 22 of the cover glass 17 has retroreflecting elements 20′, which have a relatively low elevation. This leads to a comparatively low scattering of the light L1 emitted by the flat light guide 8. In this way, a concentration or focusing of the light L1 in the second partial region 22 can be achieved.

It should be noted that this produces an inhomogeneous retroreflector light function. This is because light rays L1 in the first partial region 21 of the cover glass 17 are reflected differently than light rays L2 in the second partial region 22 of the cover glass 17.

FIG. 4 shows that only the tips of the retroreflecting elements 20 of the cover glass 17 are in contact with the optical foil 4 with the greatest possible elevation.

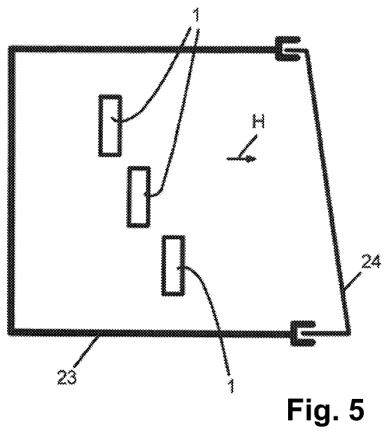

According to an embodiment of the invention as shown in FIG. 5, several light modules 1 and/or light modules 1′ described above can be arranged next to each other offset in the main radiation direction H. For example, the light modules 1 or 1′ can be arranged in steps in a horizontal and/or vertical or diagonal direction. These light modules 1 or 1′ are located in a pot-shaped housing 23 of the lighting device, the opening of which is covered by a transparent cover glass 24. The housing shells 5 of the light modules 1 are each preferably rigidly attached to the housing 23 via fastening means not shown.

### List of Reference Symbols

1, 1′ light module
2 flat light guide unit
3 retroreflector unit
4 optical foil
5 housing shell
6 reflective foil
7 base
8 flat light guide
9 rear flat side
10 front flat side
11 light guiding direction
12, 12′ narrow sides
13 light sources
14 printed circuit board
15 fastening web
16 frame
17 cover glass
18 retroreflecting element
19 recesses
20, 20′ retroreflecting elements
21 first partial region
22 second partial region
23 housing
24 cover glass
H main radiation direction
L1, L2 light

The above description is that of current embodiments of the invention. Various alterations and changes can be made without departing from the spirit and broader aspects of the invention. This disclosure is presented for illustrative purposes and should not be interpreted as an exhaustive description of all embodiments of the invention or to limit the scope of the claims to the specific elements illustrated or described in connection with these embodiments. Any reference to elements in the singular, for example, using the articles “a,” “an,” “the,” or “said,” is not to be construed as limiting the element to the singular.

1. A lighting device for vehicles, comprising:
a flat light guide unit configured to generate a predetermined light function, the flat light guide unit including a flat light guide having opposite flat sides at which coupled-in light is totally internally reflected in a light guiding direction, and a narrow side connecting the opposite flat sides, wherein light generated by a light source is coupled into the flat light guide through the narrow side; and
a retroreflector unit configured to generate a retroreflecting function, the retroreflector unit including a plurality of retroreflecting elements arranged in a surface, wherein the retroreflector unit is arranged offset in a main radiation direction relative to the flat light guide, and wherein the flat light guide is arranged behind the retroreflector unit in the main radiation direction.

2. The lighting device according to claim 1, wherein the flat light guide has a rear flat side and a front flat side arranged in front of the rear flat side in the main radiation direction, and wherein a reflective element is arranged on the rear flat side, the reflective element having a reflective surface configured to reflect light coupled out of the rear flat side back into the flat light guide.

3. The lighting device according to claim 2, wherein the reflective element comprises a reflective foil or a mirrored or reflective inner surface of a housing shell that accommodates the flat light guide and the retroreflector unit.

4. The lighting device according to claim 1, wherein the retroreflector unit is arranged flat and parallel to the flat light guide, and wherein at least one transparent optical foil or a transparent optical plate is disposed between the flat light guide and the retroreflector unit, the transparent optical foil or the transparent optical plate having a micro-optical structure.

5. The lighting device according to claim 4, wherein the retroreflector unit is integrated in a cover glass arranged in front of the transparent optical foil or the transparent optical plate in the main radiation direction.

6. The lighting device according to claim 5, wherein the cover glass, the transparent optical foil or the transparent optical plate, and the flat light guide are sandwiched together, and wherein at least the cover glass is enclosed by a housing frame that is firmly connected to a housing shell.

7. The lighting device according to claim 5, wherein the plurality of retroreflecting elements are arranged on a rear side of the cover glass facing the flat light guide, the rear side lying directly against the flat light guide or against a transparent optical foil or a transparent optical plate arranged between the flat light guide and the cover glass.

8. The lighting device according to claim 7, wherein each of the plurality of retroreflecting elements is configured as a triple optical element corresponding to a contour of a cube cut off at a single edge.

9. The lighting device according to claim 7, wherein the plurality of retroreflecting elements are distributed over an entire surface of the rear side of the cover glass.

10. The lighting device according to claim 7, wherein each of the plurality of retroreflecting elements rises from a respective base surface on the rear side of the cover glass, the base surface having a size between 1 mm and 4 mm.

11. The lighting device according to claim 7, wherein each of the plurality of retroreflecting elements is a micro retroreflecting element rising from a respective base surface on the rear side of the cover glass, the base surface having a size between 0.3 mm and 0.9 mm.

12. The lighting device according to claim 1, wherein the light source comprises a light-emitting diode.

13. The lighting device according to claim 5, wherein the cover glass is configured to be one of crystal clear or colored depending on a desired signal light function.

14. The lighting device according to claim 1, wherein the retroreflector unit includes partial regions in which retroreflecting elements of different dimensions are arranged such that focusing of light coupled out by the flat light guide is generated.

15. The lighting device according to claim 5, wherein the plurality of retroreflecting elements of the retroreflector unit are formed on a rear side of the cover glass.
